(19) United States
(12) Patent Application Publication
(10) Pub. No.: US 2012/0314087 A1
(43) Pub. Date: Dec. 13, 2012

(54) Visual source management system

(76) Inventors: Hing S. Tong, (US); Darwin Chang, (US)

(21) Appl. No.: 13/134,573

(22) Filed: Jun. 10, 2011

(51) Int. Cl. H04N 17/00

(52) U.S. Cl. 348/180; 348/E17.001

(57) ABSTRACT

A visual source management system that allows simultaneous preview and control of multiple video sources and/or streams of content is provided. The processors feature easy, fast, and independent control over video and audio outputs with or without content protection. Display systems provide a number of useful configurations to allow multitasking as well as simultaneous high performance preview for easy intuitive selection of video sources for TV, television, computing, Internet, streaming, or applications.

### BACKGROUND OF THE INVENTION

1. Field of the Invention

Embodiments of the present invention generally relate to a visual source management system. More specifically, embodiments of the present invention relate to the processors or systems for simultaneous preview, control and processing of multiple simultaneous symmetric or asymmetric video sources displayed individually on multiple displays.

2. Description of the Related Art

As the growth in TV, Internet and other forms of media expand, there becomes a need to better preview and select among the broad choice of content. Additionally, more and more people choose to multi-task in a variety of ways such as watching news while analyzing and trading stocks; watching TV while social networking and gaming; or watching multiple live sports casts while enjoying friends. This invention also allows a viewer to not only see the main feed of an NBA basketball game, but also to simultaneously view multiple camera angles of the same event. Thus improving personal control over which view appears on the main screen within your home.

Previous to this invention, TV viewers used features such as “Input Selection”, “Channel Surfing”, “Electronic Program Guides” or “Picture-In-Picture”to navigate among choices of video content. Each of these required many complex or repetitive actions to use. Electronic program guides have limited or even misleading information. Picture-in-picture is a poor compromise requiring a portion of the images to be obscured or splitting precious screen-space resulting in smaller, lower-quality distorted images. Switching among video sources was slow and more often guess-work.

Previous industrial, commercial, or security solutions such as tiling, switchers, distribution amplifiers or matrix boxes failed to provide the convenience, features, functions, needs and cost of a consumer requirement typically omitting independent control of audio and video, not supporting content protected video sources, lack full resolution image quality, lacking instant one touch control of content on the primary display and/or other features.

Previous streaming content solutions such as computers, notebooks, tablets, mobile phones, routers, modems, cable-boxes or game consoles are limited by the computing resources and switching among many streams quickly cripples the responsiveness to the user. Switching web video sources caused an interruption requiring a restart, break in the action, repeated commercial advertisements, and/or many steps including authentication, synchronization and buffering of data delaying when a smooth enjoyable view can begin.

### SUMMARY OF THE INVENTION

The present invention describes processors and systems for visual source management. Visual source management allows a user or group of users to enjoy multiple independent streams of full performance content. The user has easy and fast control over which video appears on the primary display among a set of displays as well as independent control or mixing of which audio stream or streams are audible.

Combinations of three sets of unique processors are incorporated into four classes of solutions. Each class of solution further breaks down into a variety of novel application solutions including but not limited to: towers, bars, or arrays for multi-display TV's or multi-display monitors. The main display may be integrated or separate. Portions of the audio system may be integrated or separate. Each logic element can be individually or in combination integrated onto a chip. Logic or control may be centralized and/or distributed to allow chaining of systems.

As individual signals have dedicated processing power, there is no performance degradation as the number or complexity of signals grows. This invention applies equally well when viewing multiple channels of TV, PC, Internet content, game consoles, BD, DVD, other sources or any combinations thereof.

In addition to multi-tasking, the user also benefits from visual preview of available content. This simplifies the task of selecting what to watch and how to select a program on your main display or TV. There is no break in the action since your attention can seamlessly shift from a preview to the main display.

Switching on the main display becomes faster since the connection to each input device is maintained by the associated dedicated display. Previous to this invention, switching to re-establish synchronization can easily take 5-7 seconds for television content and even more for streaming Internet content.

### BRIEF DESCRIPTION OF THE DRAWINGS

Advantage of one or more disclosed embodiments may become apparent upon reading the following detailed description and upon reference to the drawings in which:

FIG. 1 is a schematic depicting an illustrative source monitoring processor, according to one or more embodiments described herein;

FIG. 2 is a schematic depicting an illustrative source flipping processor, according to one or more embodiments described herein;

FIG. 3 is a schematic depicting an illustrative TV processor, according to one or more embodiments described herein;

FIG. 4 is a schematic depicting illustrative source monitoring display systems, according to one or more embodiments described herein;

FIG. 5 is a schematic depicting illustrative source monitoring television systems, according to one or more embodiments described herein;

FIG. 6 is a schematic depicting illustrative source flipping display systems, according to one or more embodiments described herein;

FIG. 7 is a schematic depicting illustrative source flipping television systems, according to one or more embodiments described herein;

### DETAILED DESCRIPTION

Described herein are exemplary systems and methods for implementing visual source management. In the following description, numerous specific details are set forth to provide a thorough understanding of various embodiments. However, it will be understood by those skilled in the art that the various embodiments may be practiced without the specific details. In other instances, well known methods, procedures, components, and circuits have not been illustrated or described in detail so as not to obscure the particular embodiments.

The term “video” is used to improve readability and is presumed the reader understands that state of the art video includes but not limited to audio, data, metadata, control, handshaking, power, networking and/or content protection in either or both directions. Video may be implemented using a variety or combinations of information representation schemes such as TMDS, LVDS, HDMI, DisplayPort, Thunderbolt, USB, Light Peak, component video, YUV, RGB, dRGB, VGA, composite video, ATSC, DVB, VSB, QAM, MPEG, MPEG2, MPEG4, MP3, analog audio, digital audio, Dolby Digital, advanced audio coding, FLASH, HTML, XML, HTML5, EDID, Plug & Play, and other protocols. It is well known that video may be obtained from a variety of vehicles including but not limited to Internet, terrestrial broadcast, cable, satellite, fiber, disc, or tape. References to HDMI include solutions that are compatible to HDMI such as TMDS, DisplayPort or Thunderbolt. A display may be implemented using LCD, LED, OLED, bi-stable, plasma, projection, laser, or other technologies. Video processing reaches beyond selecting streams and include but not limited to mixing, blending or signal processing within one or among combinations of input signals down to the pixel or sub-pixel level in space and/or time. References to controls or remote controls presume an appropriate set of functions. The input signals are understood to include but not limited to antennae, cable boxes, satellite receivers, PC's, notebooks, tablets, phones, DVD's, BD's, VCR's, receivers, recorders, DVR's, routers, bridges, radios, modems, repeaters, video processors, and other devices. Communications and control links include but are not limited to remote controls, USB, serial, parallel, optical, wired and/or wireless.

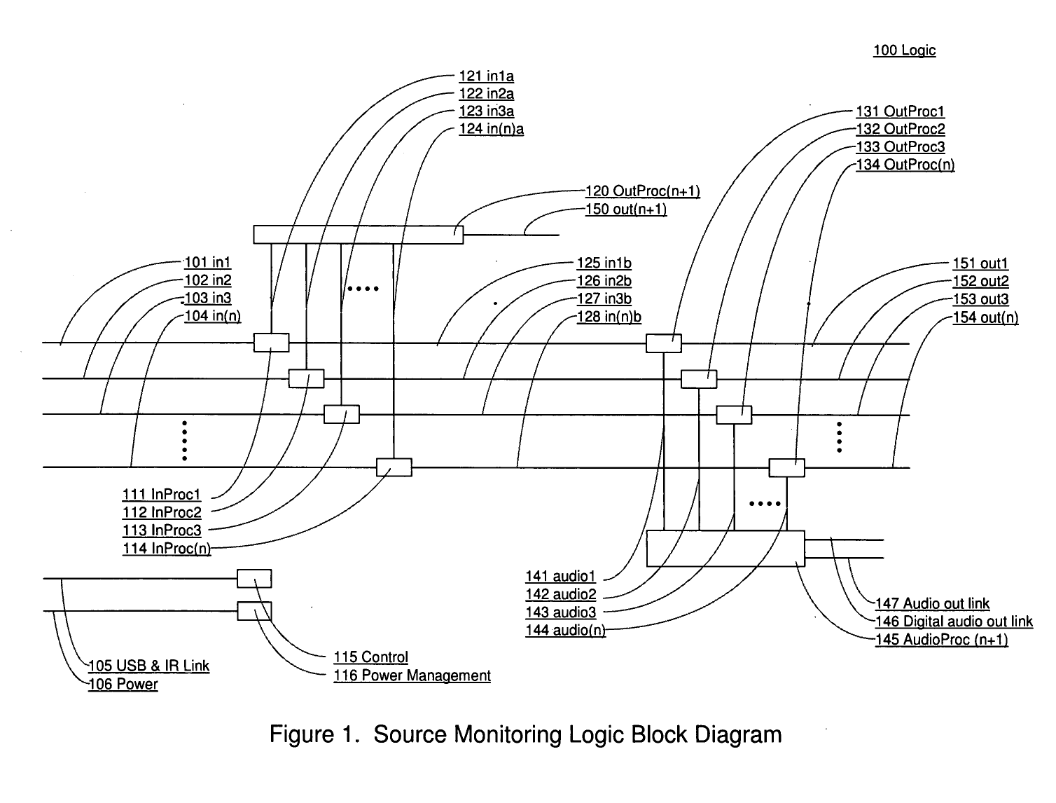

FIG. 1 is a schematic depicting an illustrative system 100 for source monitoring processor, according to one or more embodiments. In one or more embodiments, a first video input 101 is connected to a corresponding video input processor 111. A preferred embodiment of input 101 would be HDMI where each active HDMI video input link is maintained during processing. The input processor 111 replicates the input 101 into two corresponding video signals 121 and 125. One of the replicated signals 125 enters a video output processor 131 where the signal is transformed into a video output signal 151 that is suitable for display. A preferred embodiment of output 151 is LVDS. The output processor 131 also produces a corresponding audio output 141.

Similarly, the same logic flow is repeated for a number (n) of video input signals. A second input 102, a third input 103 and so forth to n^{th} input 104. These n signals are replicated by corresponding input processors (111, 112, 113, . . . 114) into two corresponding video signals (121, 122, 123, . . . 124, 125, 126, 127, . . . 128). One of each replicated video signal enters a video output processor (131, 132, 133, . . . 134). Each output processor produces n transformed video outputs (151, 152, 153, . . . 154) and n corresponding audio outputs (141,142,143, . . . 144).

The second of the n replicated signals (121, 122, 123, . . . 124) enters an n+1^{th} main video output processor 120. This output processor 120 transforms one or more of the n inputs to produce a video output signal 150. Note that there are now n+1 video output signals in total. In this way any of the n input signals can be monitored on the n outputs while having simultaneous and/or independent main output 150 to an external TV or display. A preferred embodiment of the main video output is HDMI.

The n audio signals (141, 142, 143, . . . 144) enter an audio processor 145. The audio processor 145 produces a number of common audio output formats including digital audio 146 or analog audio 147. In this way any there can be simultaneous and/or independent audio outputs (146, 147).

Power enters through an external connection 106 and conversion, distribution and management is performed by power management 116. The power management 116 may selectively sleep or wake individual elements based on user settings and system information. Control, wireless and/or wired communication links 105 enter a control unit 115. User controls such as a remote control allow selection of video and/or audio in a quick single action. Connections for power and control to the individual blocks are omitted to improve readability.

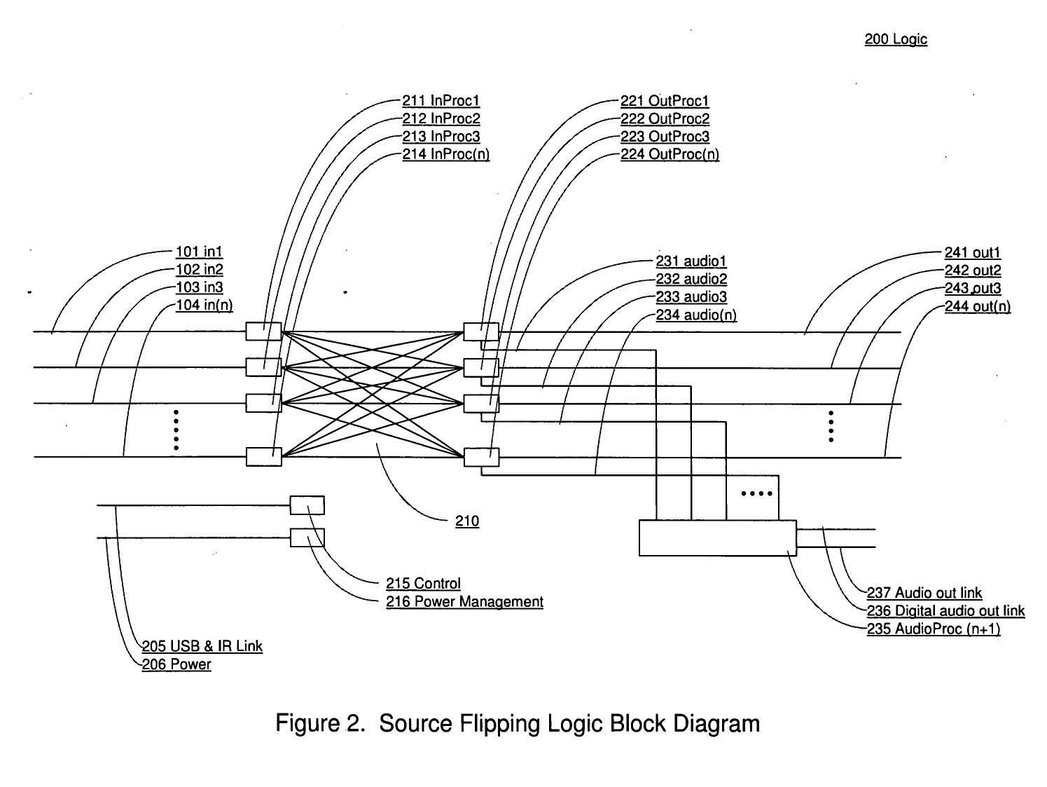

FIG. 2 is a schematic depicting an illustrative system 200 for a source flipping processor, according to one or more embodiments. In one or more embodiments, a first video input 101 is connected to a corresponding video input processor 211. A preferred embodiment of input 101 would be HDMI where each active HDMI video input link is maintained during processing. The input processor 211 replicates the input 101 into n corresponding video signals 210. One of the replicated signals 210 enters a video output processor 221 where the signal is transformed into a video output signal 241 that is suitable for display. A preferred embodiment of output 241 is LVDS. The output processor 221 also produces a corresponding audio output 231.

Similarly, the same logic flow is repeated for a number (n) of video input signals. A second input 102, a third input 103 and so forth to n^{th} input 104. These n signals are replicated by corresponding input processors (211, 212, 213, . . . 214) into n corresponding video signals 210. One of each replicated video signal enters a video output processor (221, 222, 223, . . . 224). Each output processor produces n transformed video outputs (241, 242, 243, . . . 244) and n corresponding audio outputs (231, 232, 234). In this way each of the n input signals (101, 102, 103, . . . 104) can appear independently and/or simultaneously on any of the n outputs (241, 242, 243, . . . 244).

The n audio signals (231, 232, 233, . . . 234) enter an audio processor 235. The audio processor 235 produces a number of common audio output formats including digital audio 236 or analog audio 237. In this way any there can be simultaneous and/or independent audio outputs.

Power enters through an external connection 206 and conversion, distribution and management is performed by power management 216. The power management 216 may selectively sleep or Wake individual elements based on user settings and system information. Control, wireless and/or wired communication links 205 enter a control unit 215. User controls such as a remote control allow selection of video and/or audio in a quick single action. Connections for power and control to the individual blocks are omitted to improve readability.

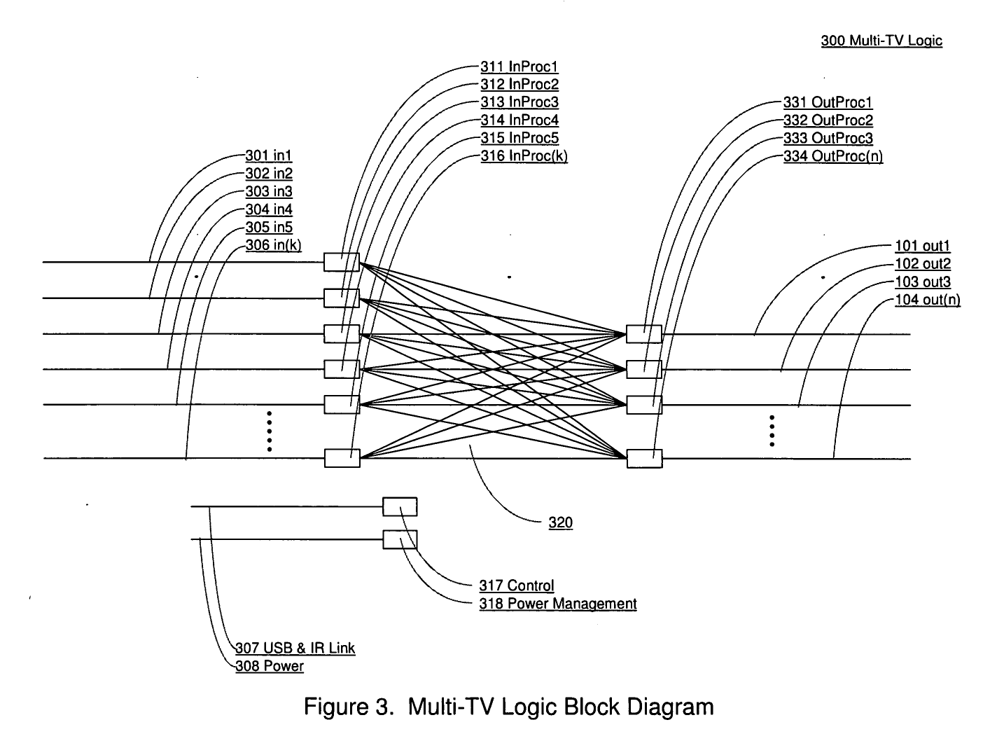

FIG. 3 is a schematic depicting an illustrative system 300 for a TV processor, according to one or more embodiments. In one or more embodiments, a first video input 301 is connected to a corresponding video input processor 311. There are a broad variety of video input signals not limited to ATSC, NTSC, DVB, HDMI, VGA, DisplayPort, Thunderbolt, component video or AV. A preferred embodiment of input 301 would be ATSC. Another embodiment of input 301 would be a network for Internet streaming data. The input processor 311 replicates the input 301 into n corresponding video signals 320. One of the replicated signals 320 enters a video output processor 331 where the signal is transformed into a video output signal 101. A preferred embodiment of output 101 is HDMI.

Similarly, the same logic flow is repeated for a number (k) of video input signals. These k video signals may be similar or different. A second input 302, a third input 303 and so forth to k^{th} input 306. These k signals are replicated by corresponding input processors (311, 312, 313, . . . 316) into k×n video signals 320 where k is greater than or equal to n. One of each replicated video signal enters a video output processor (331, 332, 333, . . . 334). Each output processor produces n transformed video outputs (101, 102, 103, . . . 104). In this way each of the k input signals (301, 302, 303, . . . 306) can appear independently and/or simultaneously on any of the n outputs (101, 102, 103, . . . 104). In a preferred embodiment, a single antenna connection on 301 can produce n distinct yet simultaneous TV channels appearing on n video output signals (101, 102, 103, . . . 104). In an embodiment where input 301 is a network connection, the network access is distributed using input processor 311 that acts as a router and can produce n distinct yet simultaneous Internet sessions appearing on n video output signals (101, 102, 103, . . . 104).

Power enters through an external connection 308 and conversion, distribution and management is performed by power management 318. The power management 318 may selectively sleep or wake individual elements based on user settings and system information. Control, wireless and/or wired communication links 307 enter a control unit 317. Connections for power and control to the individual blocks are omitted to improve readability.

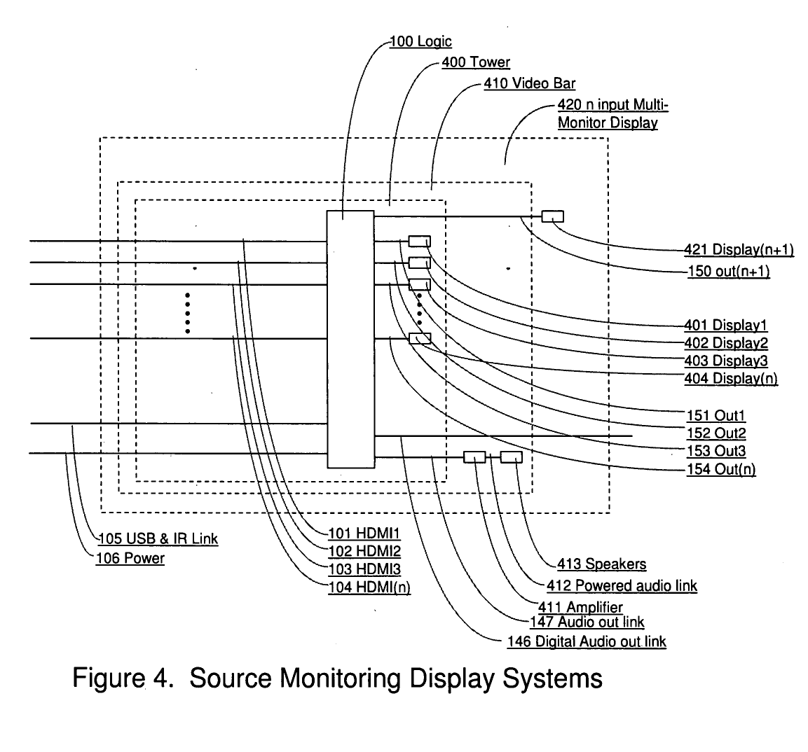

FIG. 4 is a schematic depicting illustrative systems for source monitoring display systems, according to one or more embodiments. In one or more embodiments, n video inputs (101, 102, 103, . . . 104) are connected to a source monitoring processor 100. A preferred embodiment of the n inputs would be HDMI. The source monitoring processor 100 produces n video outputs (151, 152, 153, . . . 154) which are attached to corresponding displays (401, 402, 403, . . . 404). A preferred embodiment of the n displays is a set of n flat panel LCD display.

The source monitoring processor 100 produces an n+1^{th} main video output 150 which is attached to a display 421. A preferred embodiment of display 421 is a larger flat panel LCD main display. The image on this main display 421 can be selected from any of the n input video signals (101, 102, 103, . . . 104) appearing on the n displays (401, 402, 403, . . . 404).

The source monitoring processor 100 produces a digital audio output 146 and/or an analog audio output 147. One or more channels of analog audio output are amplified by amplifier 411 producing powered audio 412 and are heard over speakers 413. The digital audio and/or analog audio can be selected to match with or independently of the main video output 150.

Power 106, communications and control 105 are connected to the system. Power management is used to selectively sleep and/or wake individual displays and/or system elements. User controls allow manual and/or assisted selection of which input video appears on the main video output 150, which audio appears on the digital audio output 146 and which audio appears on the analog audio output 147.

The source monitoring tower 400 combines the source monitoring processor 100, n displays (401, 402, 403, . . . 404) and the related signals (101, 102, 103, . . . 104, 105, 106, 151, 152, 153, . . . 154, 150, 146, 147). This source monitoring tower 400 would be used in conjunction with an external TV or display 421 and/or external sound system.

The source monitoring bar 410 combines the source monitoring processor 100, n displays (401, 402, 403, . . . 404), sound system (411, 412, 413) and the related signals (101, 102, 103, . . . 104, 105, 106, 151, 152, 153, . . . 154, 150, 146, 147). This source monitoring bar 410 would be used in conjunction with an external TV or display 421. The source monitoring bar 410 would be a standalone or add-on accessory that could be used with any TV or display for multi-tasking and/or improve the ease of selecting what appears on that external TV or display 421.

The source monitoring display 420 combines the source monitoring processor 100, n+1 displays (401, 402, 403, . . . 404, 421), sound system (411, 412, 413) and the related signals (101, 102, 103, . . . 104, 105, 106, 151, 152, 153, . . . 154, 150, 146, 147). This source monitoring display 420 could be used standalone or in conjunction with an external sound system. In this embodiment, a main display 421 would be larger then the other n smaller displays (401, 402, 403, . . . 404). The image on the main display would repeat the image of one of the n smaller displays based on the user's desires.

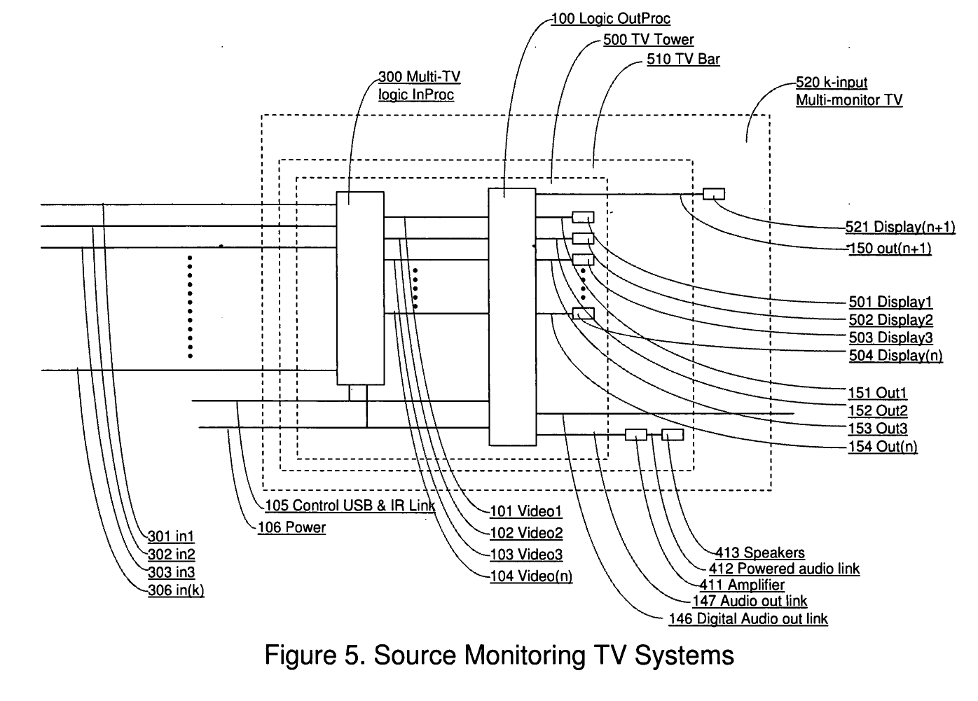

FIG. 5 is a schematic depicting illustrative systems for source monitoring TV systems, according to one or more embodiments. In one or more embodiments, k video inputs (301, 302, 303, . . . 306) are connected to a TV processor producing n video signals (101, 102, 103, . . . 104) where k is greater than or equal to n. A preferred embodiment of one of the k inputs would be ATSC. These n video inputs (101, 102, 103, . . . 104) are connected to a source monitoring processor 100. A preferred embodiment of the n inputs would be n HDMI connections. The source monitoring processor 100 produces n video outputs (151, 152, 153, . . . 154) which are attached to corresponding displays (501, 502, 503, . . . 504). A preferred embodiment of the n displays is a set of n flat panel LCD displays.

The source monitoring processor 100 produces an n+1^{th} main video output 150 which is attached to a display 521. A preferred embodiment of display 521 is a large flat panel television. The image on this main TV display 521 can be selected from any of the k input video signals (301, 302, 303, . . . 306) of which n appear on the n displays (501, 502, 503, . . . 504). For example, the entirety of n different TV channels could appear simultaneously on n displays.

The source monitoring processor 100 produces a digital audio output 146 and/or an analog audio output 147. One or more channels of analog audio output is amplified 411 producing powered audio 412 and is heard over speakers 413. The digital audio and/or analog audio can be selected to match with or independently of the main video output 150.

Power 106, communications and control 105 are connected to the system. Power management is used to selectively sleep and/or wake individual displays and/or system elements. User controls allow manual and/or assisted selection of which input video appears on the main video output 150, which audio appears on the digital audio output 146 and which audio appears on the analog audio output 147.

The source monitoring TV tower 500 combines the source monitoring processor and TV processor (100, 300), n displays (501, 502, 503, . . . 504) and the related signals (301, 302, 303, . . . 306, 101, 102, 103, . . . 104, 105, 106, 151, 152, 153, . . . 154, 150, 146, 147). This source monitoring TV tower 500 would be used in conjunction with an external TV or display 521 and/or external sound system.

The source monitoring TV bar 510 combines the source monitoring processor and TV processor (100, 300), n displays (501, 502, 503, . . . 504), sound system (301, 302, 303, . . . 306, 411, 412, 413) and the related signals (101, 102, 103, . . . 104, 105, 106, 151, 152, 153, . . . 154, 150, 146, 147). This source monitoring TV bar 510 would be used in conjunction with an external TV or display 521. The source monitoring TV bar 510 would be a standalone or add-on accessory that could be used with any TV or display for multi-tasking and/or improve the ease of selecting what appears on that external TV or display 521.

The source monitoring television 520 combines the source monitoring processor and TV processor (100, 300), n+1 displays (501, 502, 503, . . . 504, 521), sound system (411, 412, 413) and the related signals (301, 302, 303, . . . 306, 101, 102, 103, . . . 104, 105, 106, 151, 152, 153, . . . 154, 150, 146, 147). This source monitoring television 520 could be used standalone or in conjunction with an external sound system. In this embodiment, a main display 521 would be larger then the other n smaller displays (501, 502, 503, . . . 504). The image on the main display would repeat the image of one of the n smaller displays based on the user's desires.

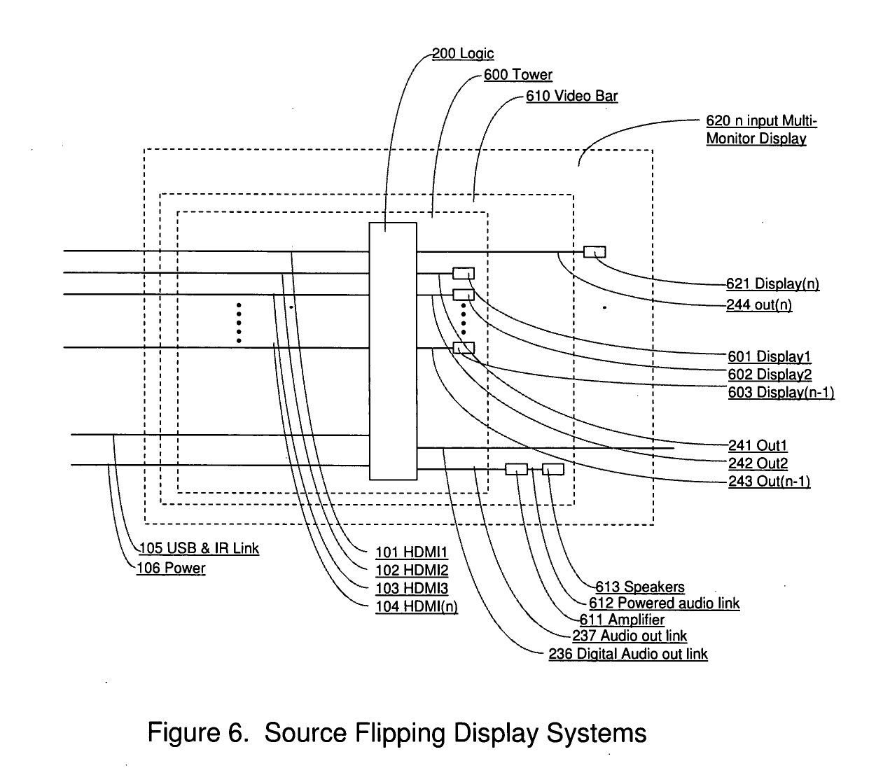

FIG. 6 is a schematic depicting illustrative systems for source flipping display systems, according to one or more embodiments. In one or more embodiments, n video inputs (101, 102, 103, . . . 104) are connected to a source flipping processor 200. A preferred embodiment of the n inputs would be n HDMI connections. The source flipping processor 200 produces n video outputs (241, 242, 243, . . . 244) which are attached to corresponding displays (601, 602, 603, . . . 621). A preferred embodiment of the n displays is a set of n flat panel LCD displays of which one display 621 is larger. The image on this main display 621 can be selected from any of the n input video signals (101, 102, 103, . . . 104) appearing on the n displays (601, 602, 603, . . . 621).

The source flipping processor 200 produces a digital audio output 236 and/or an analog audio output 237. One or more channels of analog audio output is amplified 611 producing powered audio 612 and is heard over speakers 613. The digital audio and/or analog audio can be selected to match with or independently of the main video output 244.

Power 106, communications and control 105 are connected to the system. Power management is used to selectively sleep and/or wake individual displays and/or system elements. User controls allow manual and/or assisted selection of which input video appears on the main video output 244, which audio appears on the digital audio output 236 and which audio appears on the analog audio output 237.

The source flipping tower 600 combines the source flipping processor 200, n−1 displays (601, 602, . . . 603) and the related signals (101, 102, 103, . . . 104, 105, 106, 241, 242, . . . 243, 244, 236, 237). This source flipping tower 600 would be used in conjunction with an external TV or display 621 and/or external sound system.

The source flipping bar 610 combines the source flipping processor 200, n−1 displays (601, 602, . . . 603), sound system (611, 612, 613) and the related signals (101, 102, 103, . . . 104, 105, 106, 241, 242, . . . 243, 244, 236, 237). This source flipping bar 610 would be used in conjunction with an external TV or display 621. The source flipping bar 610 would be a standalone or add-on accessory that could be used with any TV or display for multi-tasking and/or improve the ease of selecting what appears on that external TV or display 621.

The source flipping display 620 combines the source flipping processor 200, n displays (601, 602, . . . 603, 621), sound system (611, 612, 613) and the related signals (101, 102, 103, . . . 104, 105, 106, 241, 242, . . . 243, 244, 236, 237). This source flipping display 620 could be used standalone or in conjunction with an external sound system. In this embodiment, a main display 621 would be larger then the other n−1 smaller displays (601, 602, . . . 603). The image on the main display can be exchanged the image of one of the n−1 smaller displays based on the user's desires. A preferred embodiment would be where n=2 and the source flipping display 620 consists of one large display 621 and one small display 601.

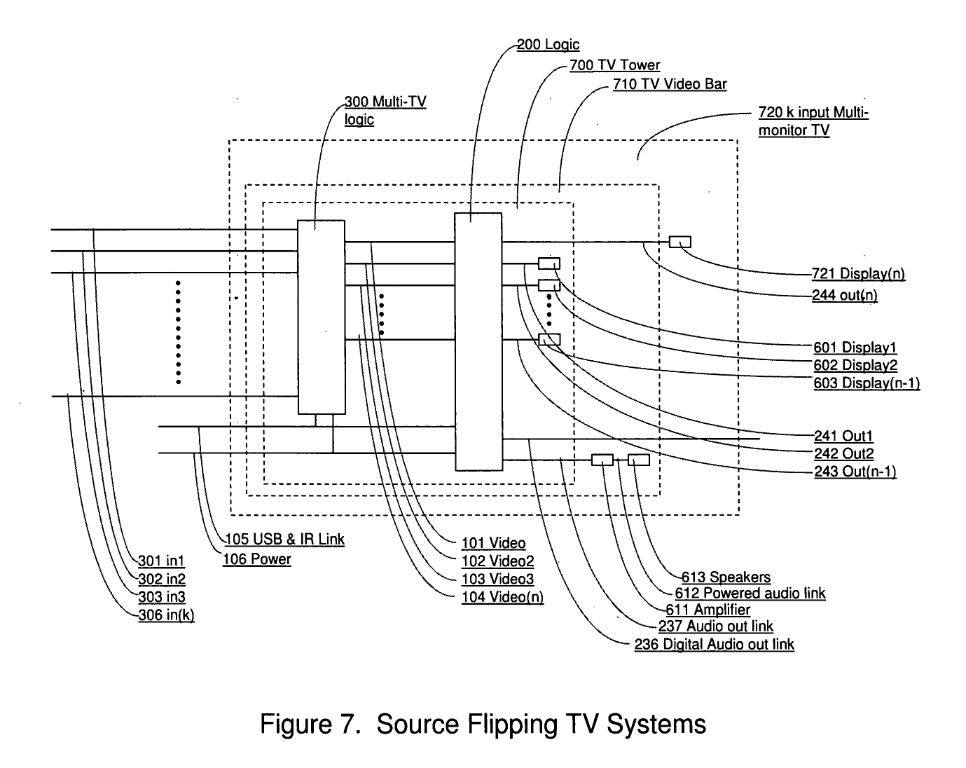

FIG. 7 is a schematic depicting illustrative systems for source flipping television systems, according to one or more embodiments. In one or more embodiments, k video inputs (301, 302, 303, . . . 306) are connected to a TV processor 300 producing n video signals (101, 102, 103, . . . 104) where k is greater than or equal to n. A preferred embodiment of one of the k inputs would be ATSC. These n video inputs (101, 102, 103, . . . 104) are connected to a source flipping processor 200. A preferred embodiment of the n inputs would be HDMI. The source flipping processor 200 produces n video outputs (241, 242, 243, . . . 244) which are attached to corresponding displays (601, 602, 603, . . . 721). A preferred embodiment of the n displays is a set of flat panel LCD display.

A preferred embodiment of display 721 is a large flat panel television. The image on this main TV display 721 can be selected from any of the k input video signals (301, 302, 303, . . . 306) of which n appear on the n displays (601, 602, 603, . . . 721). For example, the entirety of n different TV channels could appear simultaneously on n displays.

The source flipping processor 200 produces a digital audio output 236 and/or an analog audio output 237. One or more channels of analog audio output is amplified 611 producing powered audio 612 and is heard over speakers 613. The digital audio and/or analog audio can be selected to match with or independently of the main video output 244.

Power 106, communications and control 105 are connected to the system. Power management is used to selectively sleep and/or wake individual displays and/or system elements. User controls allow manual and/or assisted selection of which input video appears on the main video output 244, which audio appears on the digital audio output 236 and which audio appears on the analog audio output 237.

The source flipping TV tower 700 combines the source flipping processor and TV processor (200, 300), n−1 displays (601, 602, . . . 603) and the related signals (301, 302, 303, . . . 306, 101, 102, 103, . . . 104, 105, 106, 241, 242, . . . 243, 244, 236, 237). This source flipping TV tower 700 would be used in conjunction with an external TV or display 721 and/or external sound system.

The source flipping TV bar 710 combines the source flipping processor and TV processor (200, 300), n−1 displays (601, 602, . . . 603), sound system (611, 612, 613) and the related signals (301, 302, 303, . . . 306, 101, 102, 103, . . . 104, 105, 106, 241, 242, . . . 243, 244, 236, 237). This source flipping TV bar 710 would be used in conjunction with an external TV or display 721. The source flipping TV bar 710 would be a standalone or add-on accessory that could be used with any TV or display for multi-tasking and/or improve the ease of selecting what appears on that external TV or display 721.

The source flipping television 720 combines the source flipping processor and TV processor (200, 300), n displays (601, 602, . . . 603, 721), sound system (611, 612, 613) and the related signals (301, 302, 303, . . . 306, 101, 102, 103, . . . 104, 105, 106, 241, 242, . . . 243, 244, 236, 237). This source flipping television 720 could be used standalone or in conjunction with an external sound system. In this embodiment, a main display 721 would be larger then the other n−1 smaller displays (601, 602, . . . 603). The image on the main display can be exchanged the image of one of the n−1 smaller displays based on the user's desires. A preferred embodiment would be where n=2 and the source flipping television 720 consists of one large display 721 and one small display 701.

What is claimed is:

1) A system for a source monitoring processor comprising:
a first set of n video input connections;
a set of n input processors to receive each of the n video inputs;
a second set of n video signals from the n input processors;
a third set of set of n video signals from the n input processors;
a set of n output processors;
a forth set of n video output connections from the n output processors;
an n+1^{th} main output processor that takes in the entire third set of n video signals;
an n+1^{th} main video output signal from the n+1^{th} main output processor;
a set of n audio signals from each of the n output processors;
an audio processor that takes in the entire set of audio signals;
an least one audio output signal from the audio processor;
a power connection;
a power management system;
a communications connection;
a control system;
wherein n is a positive integer greater than or equal to 2;
wherein each input processor analyzes the first input video signal and produces the corresponding second video signal and third video signals;
wherein each output processor analyzes a second video signal and produces a corresponding forth video output signal and a corresponding audio signal;
wherein the n+1^{th} main video processor analyzes the third set of n video signals and produces the main video output signal;
wherein the audio processor analyzes the set of n audio signals and produces an audio output signal;
wherein the power management system provide power to the system;
wherein the control system provides user information and coordination among system elements.

2) The system of claim 1,
wherein the first set of n input video signals is HDMI;
wherein the main video output signal is HDMI.

3) A system for a source flipping processor comprising:
a first set of n video input connections;
a set of n input processors to receive each of the n video inputs;
a set of n output processors;
a matrix of video signals from each of the n input processors to each of the n output processors;
a second set of n video output connections from the n output processors;
a set of n audio signals from each of the n output processors;
an audio processor that takes in the entire set of n audio signals;
at least one audio output signal from the audio processor;
a power connection;
a power management system;
a communications connection;
a control system;
wherein n is a positive integer greater than or equal to 2;
wherein the matrix of video signals connects each input processor to each output processor;
wherein each input processor analyzes the first input video signal and produces the corresponding n video signals in the matrix of video signals between the n input processors and n output processors;
wherein each output processor analyzes a set of n video signals, one from each of the n respective input processors and produces a video output signal;
wherein the audio processor analyzes the set of n audio signals and produces an audio output signal;
wherein the power management system provide power to the system;
wherein the control system provides user information and coordination among system elements.

4) The system of claim 3,
wherein the first set of n input video signals is HDMI;
wherein at least one of n video output signals is HDMI.

5) A system for a TV processor comprising:
a first set of k video input connections;
a set of k input processors to receive each of the k video inputs;
a set of n output processors;
a matrix of video signals from each of the k video input processors to each of the n video output processors;
a second set of set of n video output signals from the n output processors;
a power connection;
a power management system;
a communications connection;
a control system;
wherein n is a positive integer greater than or equal to 2;
wherein k is a positive integer greater than or equal to n;
wherein each input processor analyzes the first input video signal and distributes a video signal to each of the n output processors;
wherein each output processor analyzes a set of k video signals, one from each of the k respective input processors and produces a video output signal;
wherein the power management system provide power to the system;
wherein the control system provides user information and coordination among system elements.

6) The system of claim 5:
wherein at least one of the set of k input video signals is a TV antenna signal;
wherein the input processor for the TV antenna signal is a distribution amplifier;
wherein each of the n output processors can process a TV antenna signal;
wherein at least one of the second set of n video output signals from the output processors is HDMI.

7) The system of claim 5:
wherein at least one of the set of k input video signals is a network signal;
wherein the input processor for the network signal is a network router;
wherein each of the n output processors can receive and decode Internet streaming video data;
wherein at least one of the second set of n video output signals from the output processors is HDMI.

8) A system for a source monitoring tower comprising:
a first set of n video input connections;
a processor function;
a second set of n video output signals;
a set of n displays;
a main video output;
at least one audio output signal;
a power connection;
a communications connection;
wherein n is a positive integer greater than or equal to 2;
wherein the processor function analyzes the first set of n input video signals and outputs a second set of n video output signals;
wherein the processor function analyzes the first set of n video signals to produce the main video output signal;
wherein each of the second set of n video output signals is attached to a corresponding display;
wherein the processor function analyzes the first set of n video signals and produces an audio output signal;
wherein the processor function provides power management to the system;
wherein the processor function provides control to the system.

9) The system of claim 8:
wherein each of the video signals in the first set of n input video signals are HDMI;
wherein the n displays are liquid crystal displays (LCD);
wherein the main video output signal is HDMI;
wherein the signal on the main video output would produce an image similar to the image on one of the displays in the set of n displays;
wherein the audio output signal can be selected to be the same or different as that on the main video signal.

10) A system for a source monitoring display comprising:
a first set of n video input connections;
a processor function;
a second set of n video output signals;
a set of n displays;
a main video output;
a main display;
at least one audio output signal;
an audio system;
a power connection;
a communications connection;
wherein n is a positive integer greater than or equal to 2;
wherein the processor function analyzes the first set of n input video signals and outputs a second set of n video output signals;
wherein each of the second set of n video output signals is attached to a corresponding display;
wherein the processor function analyzes the first set of n video signals to produce the main video output signal;
wherein the main video output signal is attached to the main display;
wherein the processor function analyzes the first set of n video signals and produces an audio output signal;
wherein the audio system produces amplified sound through at least one speaker;
wherein the processor function provides power management to the system;
wherein the processor function provides control to the system.

11) The system of claim 10:
wherein each of the video signals in the first set of n input video signals are HDMI;
wherein the n displays are liquid crystal displays (LCD);
wherein the main display is a liquid crystal display (LCD), wherein the image on the main display is similar to the image on one of the displays in the set of n displays;
wherein the main display is at least the same size or larger than one of the n displays;
wherein the audio output signal can be selected to be the same or different as that on the main video signal.

12) A system for a source monitoring TV tower comprising:
a first set of k video input connections;
an input processor function;
a second set of n video signals;
an output processor function;
a third set of n video output signals;
a set of n displays;
a main video output;
at least one audio output signal;
a power connection;
a communications connection;
wherein n is a positive integer greater than or equal to 2;
wherein k is a positive integer greater than or equal to n;
wherein the input processor function analyzes the first set of k input video signals and outputs a second set of n video signals;
wherein the output processor function analyzes the second set of n video signals to produce the third set of n video output signals;
wherein the output processor function analyzes the second set of n video signals to produce the main video output signal;
wherein each of the third set of n video output signals is attached to a corresponding display;
wherein the output processor function analyzes the second set of n video signals and produces an audio output signal;
wherein the processor function provides power management to the system;
wherein the processor function provides control to the system.

13) The system of claim 12:
wherein at least one of the set of k input video signals is a TV antenna signal;
wherein the n displays are liquid crystal displays (LCD);
wherein the main video output signal is HDMI;
wherein the signal on the main video output would produce an image similar to the image on one of the displays in the set of n displays;
wherein the audio output signal can be selected to be the same or different as that on the main video signal.

14) A system for a source monitoring television display comprising:
a first set of k video input connections;
an input processor function;
a second set of n video signals;
an output processor function;
a third set of n video output signals;
a set of n displays;
a main video output;
a main display;
at least one audio output signal;
an audio system;
a power connection;
a communications connection;
wherein n is a positive integer greater than or equal to 2;
wherein k is a positive integer greater than or equal to n;
wherein the input processor function analyzes the first set of k input video signals and outputs a second set of n video signals;
wherein the output processor function analyzes the second set of n video signals to produce the third set of n video output signals;
wherein the output processor function analyzes the second set of n video signals to produce the main video output signal;
wherein each of the third set of n video output signals is attached to a corresponding display;
wherein the main video output signal is attached to the main display;
wherein the output processor function analyzes the second set of n video signals and produces an audio output signal;
wherein the audio system produces amplified sound through at least one speaker;
wherein the processor function provides power management to the system;
wherein the processor function provides control to the system.

15) The system of claim 14:
wherein at least one of the set of k input video signals is a TV antenna signal;
wherein the set of n displays are liquid crystal displays (LCD);
wherein the main display is a liquid crystal display (LCD);
wherein the signal on the main video output would produce an image similar to the image on one of the displays in the set of n displays;
wherein the main display is at least the same size or larger than one of the n displays;
wherein the audio output signal can be selected to be the same or different as that on the main video signal.

16) A system for a source flipping tower comprising:
a first set of n video input connections;
a processor function;
a second set of n video output signals;
a set of n−1 displays;
at least one audio output signal;
a power connection;
a communications connection;
wherein n is a positive integer greater than or equal to 2;
wherein the processor function analyzes the first set of n input video signals and outputs a second set of n video output signals;
wherein n−1 of the second set of n video output signals is attached to a corresponding display;
wherein the remaining main video output signal of the second set of n video output signals is attached to a main video output connector;
wherein the processor function analyzes the first set of n video signals and produces an audio output signal;
wherein the processor function provides power management to the system;
wherein the processor function provides control to the system.

17) The system of claim 16:
wherein each of the video signals in the first set of n input video signals are HDMI;
wherein the n−1 displays are liquid crystal displays (LCD);
wherein the remaining main video output signal of the second set of n video output signals is HDMI;
wherein the signal on the n output video signals may be exchanged;
wherein the audio output signal can be selected to be the same or different as that on the main video signal.

18) A system for a source flipping display comprising:
a first set of n video input connections;
a processor function;
a second set of n video output signals;
a set of n displays;
at least one audio output signal;
an audio system;
a power connection;
a communications connection;
wherein n is a positive integer greater than or equal to 2;
wherein the processor function analyzes the first set of n input video signals and outputs a second set of n video output signals;
wherein each of the signals in the second set of n video output signals is attached to a corresponding display;
wherein the processor function analyzes the first set of n video signals and produces an audio output signal;
wherein the audio system produces amplified sound through at least one speaker;
wherein the processor function provides power management to the system;
wherein the processor function provides control to the system.

19) The system of claim 18:
wherein each of the video signals in the first set of n input video signals are HDMI;
wherein the set of n displays are liquid crystal displays (LCD);
wherein a main display is at least the same size or larger than the remainder of the n displays.
where the image on the n displays may be exchanged;
wherein the audio output signal can be selected to be the same or different as that on the main video signal.

20) A system for a source flipping TV tower comprising:
a first set of k video input connections;
an input processor function;
a second set of n video signals;
an output processor function;
a third set of n video output signals;
a set of n−1 displays;
a main video output;
at least one audio output signal;
a power connection;
a communications connection;
wherein n is a positive integer greater than or equal to 2;
wherein k is a positive integer greater than or equal to n;
wherein the input processor function analyzes the first set of k input video signals and outputs a second set of n video signals;
wherein the output processor function analyzes the second set of n video signals to produce the third set of n video output signals;
wherein n−1 of the third set of n video output signals is attached to a corresponding display;
wherein the output processor function analyzes the second set of n video signals and produces an audio output signal;
wherein the processor function provides power management to the system;
wherein the processor function provides control to the system.

21) The system of claim 20:
wherein at least one of the set of k input video signals is a TV antenna signal;
wherein the set of n−1 displays are liquid crystal displays (LCD);
wherein the main video output signal is HDMI;
wherein the signal on the second set of n video output signals may be exchanged;
wherein the audio output signal can be selected to be the same or different as that on the main video signal.

22) A system for a source flipping television comprising:
a first set of k video input connections;
an input processor function;
a second set of n video signals;
an output processor function;
a third set of n video output signals;
a set of n displays;
at least one audio output signal;
an audio system;
a power connection;
a communications connection;
wherein n is a positive integer greater than or equal to 2;
wherein k is a positive integer greater than or equal to n;
wherein the input processor function analyzes the first set of k input video signals and outputs a second set of n video signals;
wherein the output processor function analyzes the second set of n video signals to produce the third set of n video output signals;
wherein each of the third set of n video output signals is attached to a corresponding display;
wherein the output processor function analyzes the second set of n video signals and produces an audio output signal;
wherein the audio system produces amplified sound through at least one speaker;
wherein the processor function provides power management to the system;
wherein the processor function provides control to the system.

23) The system of claim 22:
wherein at least one of the set of k input video signals is a TV antenna signal;
wherein the set of n displays are liquid crystal displays (LCD);
wherein one of the n displays is at least the same size or larger than the rest of the n displays;
wherein the signal on the second set of n video output signals may be exchanged;
wherein the audio output signal can be selected to be the same or different as that on the main video signal.

24) The system of claim 22:
wherein at least one of the set of k input video signals is a network signal;
wherein the input processor for the network signal is a network router;
wherein each of the n output processors can receive and decode Internet streaming video data;
wherein the set of n displays are liquid crystal displays (LCD);
wherein one of the n displays is at least the same size or larger than the rest of the n displays;
wherein the signal on the second set of n video output signals may be exchanged;
wherein the audio output signal can be selected to be the same or different as that on the main video signal.
